(19) United States
(12) Patent Application Publication
(10) Pub. No.: US 2012/0274945 A1
(43) Pub. Date: Nov. 1, 2012

(54) METHOD AND SYSTEM FOR STRUCTURAL ANALYSIS OF AN OBJECT BY MEASURING THE WAVE FRONT THEREOF

(75) Inventors: Pierre Bon, Marseille (FR); Benoit Wattellier, Paris (FR); Serge Monneret, Marseille (FR); Hugues Giovanini, Allauch (FR); Guillaume Maire, Marseille (FR)

(73) Assignees: UNIVERSITE PAUL CEZANNE AIX-MARSEILLE III, Aix En Provence Cedex 1 (FR); PHASICS, Soisy Sur Seine (FR)

(21) Appl. No.: 13/500,385

(22) PCT Filed: Oct. 8, 2010
(86) PCT No.: PCT/FR2010/052128

§ 371 Date: Jun. 28, 2012

(30) Foreign Application Priority Data
Oct. 8, 2009 (FR) 0904806

(51) Int. Cl. G01B 11/24

(52) U.S. Cl. 356/512; 356/601; 356/612

(57) ABSTRACT

A system for structural analysis of an object, including a device for generating an input light beam arranged so as to cause the input beam generated to interact with at least one portion of the object, and a device for receiving the output light beam resulting from the interaction between the input beam and the object. In this system, the receiving device include a wavefront analyzer arranged so as to measure the electromagnetic field of the wave of the output beam received, and the generating device has a spatial coherence adapted to that of the receiving device. A structural analysis method implementing such a system is presented.

### BACKGROUND

1. Technical Field

This invention relates to the field of structural analysis of objects. This type of metrological analysis consists of optical tomography enabling the surface topology of opaque objects to be determined or the volume of transparent objects to be reconstructed. It is thus capable of being applied, in particular, in biological and medical fields (tomography of cells, skin) and materials (tomography of structured materials, reading of invisible 3D structures such as impurities, memories, counterfeit products).

It relates more specifically to a system for structural analysis of an object, including means for generating an input light beam, arranged to cause the input beam generated to interact with at least one portion of the object, and means for receiving the output light beam resulting from the interaction between the input beam and the object.

It also relates to a method for structural analysis of an object, including a step of generating an input light beam capable of interacting with at least one portion of the object, and a step of receiving the output light beam resulting from the interaction between the input beam and the object.

2. Prior Art

The tomography solution best known consists of X-ray tomography, as described, for example, in the patent document US 2005 0117696 A1. In such a tomography system, an X-ray generator is imaged on a two-dimensional X-ray sensor so as to measure the absorbance of said rays through the object to be analysed. To do this, the X-ray beam generated illuminates the object and the sensor is arranged so that the object is inserted between the generator and the sensor. The latter are turned with respect to the object so as to have different orientations with respect to the object, while the object remains inserted between them. The combining of the absorbance measurements according to the different orientation angles then enables a 3D reconstruction of the object to be made.

Nevertheless, because of the use of X-rays, which requires placing the samples under vacuum, this solution is not compatible with in vivo observations of biological tissues. Moreover, for certain applications associated with nanotechnologies, it is useful not only to determine the dimensions and shape of the samples, but also to known their permittivity distribution. This information indeed provides information on the materials comprising the samples. The number of potential applications of X-ray imaging is therefore limited. A transposition and adaptation of the techniques used in the field of X-rays, to the optical field, opens up numerous fields of applications.

There are microscopy systems that perform vertical scanning (z-scan) through the object and thus provide an image of the intensity diffracted by each plane inside the object and resulting from the scanning, thereby enabling the reflected intensity (reflectance) of the object to be reconstructed in 3 dimensions. However, this principle, based on intensity measurements, does not enable the phase information of the field diffracted by the object to be extracted.

The general problem addressed in the field of optical tomography concerns the three-dimensional reconstruction of the complex refraction index of a sample. This information, which is dependent both on geometric parameters (the dimensions) of the object and its optical properties (three-dimensional distribution of the complex refraction index) cannot be determined, in the general case, solely on the basis of light intensity measurements of the field diffracted by the sample obtained with a conventional sensor. It is necessary to know the complex value of the diffracted field. However, the intensity measured by the conventional sensors is only the square of the amplitude of this field. It is necessary, in addition to this intensity measurement, to obtain a measurement of the phase of the field diffracted by the sample.

The vertical scanning microscopy systems do not enable, in the general case, the three-dimensional reconstruction of the complex refraction index of an object to be analysed.

A solution envisaged in order to solve this problem consists of producing a system for diffraction tomography by holography. In such a system, a laser and a reference path are used to acquire a plurality of holograms of an object by interferometry, making it possible to access, at the same time, the phase and amplitude of the wave diffracted by the object. The three-dimensional structure of the object is then recovered by digital methods such as that proposed by Emil Wolf in 1969, in his article “Three-dimensional structure determination of semitransparent objects from holographic data” (Opt. Commun., 1. IS3-156, 1969).

More specifically, the publication “Tomographic phase microscopy” (Wonshik Choi et al., Nature Methods, September 2007, Vol. 4, No. 9, p. 707-717) discloses a tomography system enabling three-dimensional measurements of the refraction index of cellular or multicellular organisms that does not require any disturbance of the sample or immersion in a specific medium. For this, the system includes a heterodyne Mach-Zehnder interferometer, which provides phase images based on interference figures spaced apart in time, due to the frequency modification of a reference beam with respect to the beam passing through the sample. A separating plate divides a laser beam (resulting from a helium-neon laser) into two parts so as to cause them to pass respectively through the sample arm and the reference arm. An adjustable mirror mounted with a galvanometer enables the angle of incidence of the illumination to be varied. In the reference arm, two acousto-optic modulators modify the frequency of the reference beam. The beams are then recombined so as to produce an interference figure in the image plane. For each illumination angle, a camera records a plurality of images so that the phase shift between the sample and reference is equal to π/2. The phase images are finally calculated by phase shift interferometry.

Analogous systems, for diffraction tomography by holography, are described in the publications “Living specimen tomography by digital holographic microscopy: morphometry of testate amoeba” (Florian Charrière et al., Optics Express, 7 Aug. 2006, Vol. 14, No. 16, pp. 7005-7013) and “High-resolution three-dimensional tomographic diffractive microscopy of transparent inorganic and biological samples” (M. Debailleul et al., Optics Letters, 1 Jan. 2009, Vol. 34, No. 1, pp. 79-81). A plurality of alternatives of these systems can be produced, for example, by making the sample turn rather than the illumination, or by using a Michelson interferometer instead of a Mach-Zehnder interferometer (V. Lauer. Journal of Microscopy, Vol. 205, February 2002, pp. 165-176).

While they enable the amplitude and phase of the refraction index of the sample (or its real and imaginary parts) to be reconstructed in order to reconstruct its complex local refraction index, these tomography systems nevertheless have a number of disadvantages. First, they involve the use of sources with high temporal coherence, such as lasers. Then, there are problems of parasitic reflections and speckle effects, which have a detrimental effect on the 2D or 3D measurements. In addition, they require the use of a reference path, which produces significant structural complications.

Tomography solutions based on the analysis of the surface of a laser beam wave transmitted by objects, primarily using Shack-Hartmann analysers, have been proposed.

The need for image correction in astronomy, in the widest possible fields of view, has made it necessary to estimate the turbulence of the atmosphere at various altitudes (see M. Tallon and R. Foy, “Adaptive telescope with laser probe-isoplanatism and cone effect,” Astron. Astrophys. 235, 549-557 (1990) or Benoit Neichel, Thierry Fusco, and Jean-Marc Conan, “Tomographic reconstruction for wide-field adaptive optics systems: Fourier domain analysis and fundamental limitations,” J. Opt. Soc. Am. A 26, 219-235 (2009)). These systems use a plurality of natural or artificial stars. The combined analysis of the wave surfaces resulting from each of the stars independently, by a Shack-Hartmann analyser, enables so-called tomographic reconstruction of the atmosphere.

Similarly, in the field of ophthalmology, certain optical and morphological properties of the eye are derived from the analysis of a plurality of wave surfaces resulting from a plurality of source points on the retina and passing through the different components of the eye (see Real et al., Patent Application US 2003/0038921 A).

These measurements are said to be tomographic because they involve a plurality of measurements of the same object from different angles. However, because they use only phase information and not the entire electromagnetic field, they enable a three-dimensional reconstruction only with a resolution on the order of several fractions of the field of observation. At best, they enable so-called projective reconstruction methods, in which the phase shift measurements are back-projected according to the observation angles, then added in order to recompose an image.

To obtain much better resolutions, on the order of the resolution of the imaging system used, it is necessary to known the phase and the intensity of the wave transmitted, i.e. its complex electromagnetic field. These methods are not therefore transposable to the field of microscopy, in which the level of detail is on the order of the resolution of the imaging system.

Thus, none of the prior art solutions makes it possible to provide a tomography system by photon imaging limited by the resolution of imaging systems, eliminating the problems of parasitic reflections and speckle effects, while being structurally simple and compact.

### SUMMARY OF THE INVENTION

The objective of this invention is to overcome this technical problem, while enabling a three-dimensional measurement of the refraction index (or the permittivity), without requiring a reference path or illumination by a laser source. It is possible to deduce from this, for example, a measurement of the volume of confined objects (cell, cell nucleus, organelles) present in the reconstruction volume as well as the mean refraction index inside each of said objects.

To this end, the invention relates to a system for structural analysis of an object in order to produce a three-dimensional reconstruction of the structure of the portion of the object analysed according to at least one three-dimensional reconstruction method, including means for generating an input light beam, arranged so as to cause the input beam generated to interact with at least a portion of the object, and means for receiving the output light beam resulting from the interaction between the input beam and the object. In this system, the receiving means include a wavefront analyser arranged so as to measure the electromagnetic field of the wave of the output beam received, and the generating means have a spatial and/or temporal coherence adapted to that of the receiving means.

A wavefront analyser according to the invention is an apparatus that enables the scalar electromagnetic field of a light wave to be measured, i.e. that measures both its phase and its intensity. Because of its nature, it is self-referenced, the beam received serves as a reference to itself. It therefore has the advantage of not requiring a reference beam and of being insensitive to vibrations.

In addition, a wavefront analyser is a compact sensor for electromagnetic field imaging. Its capacity to recover phase and intensity information with a large spatial sampling is directly related to its performance in diffraction tomography applications. For these, high-resolution wavefront analysers are preferred.

The adaptation of the spatial coherence of the generating and receiving means is intended to provide spatially coherent light at the level of the receiving means. Indeed, wavefront analysis technologies use theories based on point light sources, said to be spatially coherent. When the light source is no longer a point light source, the analyser captures a superposition of waves, which has two effects. First, the measurement is less precise because the marginal points of the source disrupt the measurement at the centre of the source. Second, each of the points of the source will be diffracted differently by the object. Thus, the information necessary for measuring the complex electromagnetic field is diluted between the different points of the source. To perform such a spatial coherence adaptation, it is possible to envisage, according to the invention, providing a device for filtering the spatial coherence of the wave generated by the light source.

By combining diffraction tomography and wavefront analysis technologies, the invention therefore makes it possible to solve the aforementioned technical problem, while providing sufficient lateral resolution to benefit from high imaging quality.

Preferably, the generating and receiving means are arranged so as to obtain a plurality of successive measurements of the output light beam resulting from the interaction between the input beam and the object. The generating means have a spatial and/or temporal coherence also adapted to the three-dimensional reconstruction method used.

Preferably, the system is equipped with means for orienting the interaction, seen by the receiving means, between the input light beam and the portion of the object. Different orientations are applied to each measurement on the object so as to produce this 3D reconstruction.

For this, a plurality of alternatives can be envisaged. In particular, the orientation means can act on the orientation:
of the generating means,
of the object, or
both simultaneously.

Alternatively, the generating means can be structured so as to generate a plurality of input light beams capable of interacting with at least a portion of the object according to different tilts, which makes it possible to do without the aforementioned angular scanning. Different portions of this structured light source successively illuminate the object in order to produce this 3D reconstruction, which is equivalent to having obtained successive measurements at different orientations.

Preferably, and for the purposes of conjugating the plane of the analyser with the object studied, the system includes optical conjugation means between the object and the receiving means.

According to a particular embodiment enabling chromatism measurements, it is possible for the system to comprise means for spectral selection of the input light beam.

An alternative to obtaining such chromatism measurements consists of equipping the system with a plurality of generating means arranged so as to cause the interaction of a plurality of input light beams of different wavelengths with at least a portion of the object.

According to a particular embodiment enabling the polarisation of the incident light on the object to be chosen in order to obtain the anisotropic properties of a material, it is possible for the system to comprise means for polarising the input light beam.

According to different embodiments of the invention, the generating means can include a temporally incoherent laser or spectral source.

Preferably, the system includes calculation means capable of implementing an image reconstruction algorithm by digital propagation of the electromagnetic field measured in the plane of the receiving means.

According to different embodiments of the invention, the wavefront analyser can be a digital wavefront analyser (or curvature sensor), a microlens matrix wavefront analyser (Shack-Hartmann), a multilateral shift interferometry wavefront analyser (in this regard, see patent documents EP 1993 0538126 B1 and EP 2000 1061349 B1), or any other wavefront analyser based on the study of the effect of the wavefront effect on the programming of a structured light wave (Hartmann, etc.). The degree of spatial filtering will be different according to the technology used, among those mentioned above.

In the case of an at least partially transparent object, it is possible for the system to comprise a semi-reflective plate arranged between the generating means and the receiving means, as well as reflection means arranged so as to reflect the light passing through the object.

Also in this case, it is possible for the generating means and the receiving means to be arranged on each side of the object.

In the case of a reflective object, it is possible for the generating means and the receiving means to be arranged on the same side of the object.

The invention also relates to a method for structural analysis of an object in order to produce a three-dimensional reconstruction of the structure of the portion of the object analysed according to at least one three-dimensional reconstruction method, including a step of generating an input light beam capable of interacting with at least a portion of the object, and a step of receiving the output light beam resulting from the interaction between the input beam and the object. When the input light beam is received, the phase of its wave is measured by a wavefront analyser, and the spatial and/or temporal coherence of the input light beam is adapted to that of the output light beam.

Preferably, the steps for generating the input light beam and for receiving the output light beam are repeated successively, and the generating means have spatial and/or temporal coherence also adapted to the three-dimensional reconstruction method used.

### BRIEF DESCRIPTION OF THE DRAWINGS

The invention will be easier to understand in view of the detailed description of a non-limiting example of production, accompanied by figures, representing, respectively:

FIG. 1, a diagram of a structural analysis system according to a first embodiment of the invention, with rotating illumination,

FIG. 2, a diagram of a structural analysis system according to a second embodiment, with a rotating sample,

FIG. 3, a diagram of a structural analysis system according to a third embodiment, with an imaging system,

FIG. 4, a diagram of a structural analysis system according to a first embodiment, with an imaging system,

FIG. 5, a diagram of a structural analysis system according to a fifth embodiment, by reflection,

FIG. 6, a diagram of a structural analysis system according to a sixth embodiment, with a chromatic filter,

FIG. 7, a diagram of a structural analysis system according to a seventh embodiment, with a polariser,

FIG. 8, a diagram of a structural analysis system according to an eighth embodiment, for an opaque object.

For greater clarity, identical or similar elements will be designated with the same reference signs in all of the figures.

### DETAILED DESCRIPTION OF THE PREFERRED EMBODIMENT(S)

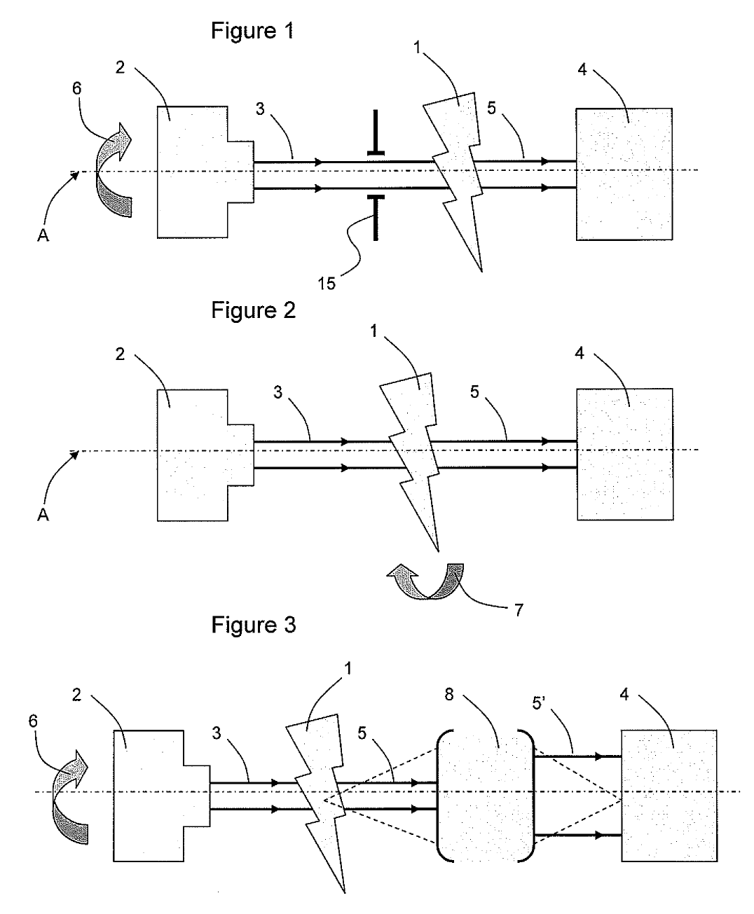

In reference to FIG. 1, a structural analysis system according to a first embodiment of the invention includes means 2 for generating an input light beam 3. This light beam is directed onto a portion of the object 1 to be analysed. Receiving means 4 enable the output light beam 5, resulting from the interaction between the input beam 3 and the object 1, to be recovered.

The object 1 is the subject of the tomographic analysis. The objective is, in this case, to reconstruct this object three-dimensionally, by an optical transmission measurement, according to a three-dimensional tomographic optical microscopy principle. This method is intended to provide a dimensional characterisation of the object or sample, via a preliminary measurement of its shape and permittivity distribution, with quantitative measurement results.

The object 1 is, in this case, an object having some transparency, so that the receiving means 4 can recover a portion of the light flux generated by the means 2 after interaction with said object and transmission through it. This object 1 can optionally be deposited on a substrate, itself arranged according to an axis perpendicular to the optical axis A of the system.

The means for generating the beam 3 can consist, for example, of a temporally coherent light source (for example, a laser) or a temporally incoherent light source (such as a white light source). A person skilled in the art will nevertheless understand that the particularity of this invention lies in the fact that it enables an incoherent light to be used, while other tomography systems require light sources with a high temporal coherence. This tomography system is not therefore limited by the chromatic dispersion of the sample and the sensitivity of the sensor constituting the analyser.

The use of a coherent light nevertheless remains possible, to the detriment of the disadvantages inherent to this type of source (speckle effect, parasitic reflections, etc.). In addition, the use of a temporally incoherent source will be preferred.

The receiving means 4 are arranged so that at least a portion of the incident beam 3 on the object 1 is directed toward them. The range of wavelengths applicable to the structural analysis system according to the invention is dependent only on the matrix sensors available, which can range in particular from the terahertz domain (microbolo-teraertz imager) to the ultraviolet and X-ray domains. More specifically, a person skilled in the art will note that it is wise to work with a wavelength of which the amplitude corresponds to that of the dimension of the details to be observed and analysed.

These means 4 also include a wavefront analyser enabling the complex electromagnetic field of the wave of the output beam 5 received to be measured, i.e. the amplitude and phase of the complex field diffracted by the object 1. This type of analyser enables a combined measurement of the mean optical index and the mechanical thickness of the object sample, without requiring a reference path, without division of the beam in front of the sample, using only the light diffracted by said sample. The mean optical index is deduced from the local complex index, which is a function both of the phase and the intensity of the diffracted wave analysed. These index and thickness measurements then enable the profile of the object (shape, permittivity distribution) and therefore its three-dimensional characterisation to be obtained.

To obtain this characterisation, an inversion algorithm based on electromagnetic field measurements is used, which algorithm can be based on the resolution of the Maxwell equations. To reconstruct a three-dimensional image, an algorithm for image reconstruction by digital propagation of the electromagnetic field generated by the input light beam 3 can be implemented.

The interference fringes generated by the wavefront analyser are recorded by the CCD sensor of a camera. The deformation of this interferogram then makes it possible to deduce the deformation of the wavefront. Indeed, if the beam received has a perfectly planar surface, the image recorded by the acquisition means (a camera) will be a perfect sinusoidal grid. If the beam received contains aberrations, this regular mesh will be deformed. The study of these deformations by spectral analysis methods then makes it possible to find spatial phase gradients, as well as the intensity (square of the electromagnetic field module). After integration of these gradients, a phase map with one measurement point per interference fringe is obtained.

A number of alternative embodiments of the wavefront analyser 4 can be envisaged in order to obtain the electromagnetic field measurement. Among them, digital wavefront analysers, curvature sensors (see the publication of Francois Roddier, Appl. Opt. 27, 1988, pp. 1223-1225) with a microlens matrix (Shack-Hartmann) or with periodic transmission optics (Hartmann) can in particular be used.

A preferred alternative however consists of a multilateral shift interferometry wavefront analyser. One of the embodiments of this technique is 4-wave interferometry. For this, a diffraction grating, also called a two-dimensional modified Hartmann mask, replicates the beam to be analysed in four sub-beams perfectly identical to the first and that are propagated in directions slightly tilted with respect to the optical axis. Because of their slight tilts, after several millimetres of propagation, these beams will be slightly separated. Interference fringes will then appear, with an interference step being dependent on the angle between the propagation directions.

This measurement by multilateral shift interferometry has the advantage of being much more spatially resolved than the closest techniques Shack-Hartmann, Hartmann). In addition, the theoretical model considers the electromagnetic field to be a continuous function, which makes this technique highly suitable for diffractive tomography. In addition, this alternative is achromatic, i.e. the deformation of the interferogram is not dependent on the wavelength but only on the optical path covered by the light. It does not require an elaborate alignment procedure and faithfully reproduces the local variations in light intensity.

Depending on the embodiment, more or less coherent sources, from a spatial or temporal perspective, will be used. The spatial coherence is primarily related to the range of the light source. In the case of a laser, this range is given by the size of the Airy disc. For so-called white light illuminations, for example with halogen sources or for light-emitting diodes, this range is the size of the emitting area. The temporal coherence concerns statistical temporal properties of the source. It is primarily related to the spectral range of the source. For example, for a laser, this spectral range or width varies from several fractions to several dozen nanometres, while for a so-called white light source, the spectrum covers the entire visible domain, i.e. several hundred nanometres.

Depending on the means for measuring the electromagnetic field and reconstructing the three-dimensional structure of the object, it will be necessary to control these two types of coherence.

The adaptation of the spatial coherence between the generating means 2 and the receiving means 4 is ensured by spatial filtering means 15. These means can, to this end, be placed between the generating means 2 and the object 1. The adjustment of the parameters of these means 15 enables a portion of the output light flux 5 to be selected so as to filter a portion of it. The determination of these adjustment parameters in order to adapt the spatial coherence between the means 2 and 4 is a practice within the abilities of a person skilled in the art.

The adaptation of the temporal coherence is performed by using spectral filtering systems at the level of the generating means 2 or at the level of the receiving means 4.

With regard to the measurement of the electromagnetic field, these adaptation means 15 thus make it possible to provide a light beam of which the spatial coherence is sufficient with regard to the CCD matrix forming the plane of the sensor integrated with the wavefront analyser 4. It was demonstrated in the publication of Pierre Bon et al. Opt. Express 17, 2009, pp. 13080-13094, that, in the case of 4-wave shift interferometry, the contrast of the interference fringes is dependent upon the spatial coherence of the light reaching the analyser. This contrast is directly associated with the ratio between the angular range of the source and the angle of view of a period of the diffraction grating based on the CCD sensor, called the critical angle of the analyser. In addition, according to the noise conditions of the measurements, it is possible to set a threshold on the contrast of the fringes in order to obtain a reliable reconstruction of the electromagnetic field. On the basis of this threshold, the range of the maximum source allowed on the analyser is obtained. For example, if this contrast threshold is set to 50%, the angular range must be less than around half the critical angle. In the case of a microlens system, the reasoning is similar and the critical angle is given by the ratio between the microlens spacing and their common focal point. With regard to temporal coherence, these two types of analysers are practically insensitive to it.

With regard to the image reconstruction algorithm, certain restrictions on the spatial and temporal coherence may apply. Most of the existing algorithms are based on the a priori knowledge of the incident wave on the object to be reconstructed. In general, it is assumed to be planar, i.e. perfectly spatially coherent, or, in an equivalent manner, to have a limited range. Using a source with a finite range can cause the measurement to go beyond the domain of validity of the physical model on which the reconstruction is based. It is possible to define domains of validity on the coherence of the source so that the measurement will not be distorted by excessive errors. These coherence domains will depend upon the embodiment of the reconstruction.

It is possible, for example, to define a coherence volume of the source at the level of the object, by adapting the criteria used in the X-ray tomography domain, as indicated by the publication of Friso van der Veen and Pfeiffer, “Coherent X-Ray Scattering”, J. Phys.: Condens. Matter 16 (2004) 5003-5030. The dimensions of this coherence volume are given transversally by the wavelength divided by the angular range of the source (Lₜᵣₐₙₛᵥₑᵣₛₑ=l/Dq in which l is the central wavelength of the source and Dg is its angular range) and axially by the length of temporal coherence of the source, directly related to its spectral width Lₐₓᵢₐₗ=l²/Dl, in which Dl is the spectral width of the source. A condition for validity of the reconstruction algorithms is that this coherence volume must be greater than the object to be reconstructed. As an illustration, if an object with a 10-μm side is to be reconstructed three-dimensionally with an illumination centred at 550 nm, the angular range of the source must be less than 55 mrad and its spectral width must be less than 30 nm.

A number of examples of spatial filtering means 15 can be envisaged. Among them, it is possible to cite a Köhler mounting, or more simply a simple aperture system.

These spatial filtering means can be mounted on all of the embodiments described below, although, for the purpose of greater clarity in the figures, they will not all be shown on them.

To be capable of reconstructing the object 1 three-dimensionally, it is necessary to measure the interaction between the incident beam 3 and the object, according to a plurality of orientations of this interaction, i.e. with different tilt angles between the beam 3 and the object 1 with respect to the receiving means 4. The digital analysis of these different measurement results then makes it possible to obtain a 3D reconstruction. For this, means 6 for orienting the interaction are used.

These means 6 for orienting the interaction consist of means for rotating the source 2 with respect to the optical axis A. These means make it possible to tilt the beam 3 generated by the source 2 with respect to the optical axis A. Since the interaction surface of the sample is perpendicular to the optical axis A, a tilt of the incident beam 3 with respect to the surface of the sample is deduced therefrom, as it is seen by the analyser 4.

Another possibility consists of using a light source 2 having a structuring of its lighting rather than angular scanning.

Now other embodiments of the invention will be described in reference to the following FIGS. 2 to 8.

In the second embodiment, in reference to FIG. 2, the means 2 for generating the incident beam 3 are fixed so that the beam 3 is parallel to the optical axis. The means for orienting the interaction 7 are now the means for rotating the sample with respect to the optical axis A. Since the source 2 is arranged so that the incident beam 2 is perpendicular to the optical axis, a tilt of the incident beam 3 with respect to the surface of the sample is derived therefrom, as it is seen by the analyser 4.

In the third embodiment, in reference to FIG. 3, the means for orienting the interaction 6 are identical to those of the first embodiment. The means 8 for optical conjugation are arranged between the object 1 and the receiving means 4. These means 8 include a lens assembly, in order to conjugate the surface of interaction of the object 1 with the plane of the sensor integrated with the wavefront analyser 4, thereby notably improving the measurement results.

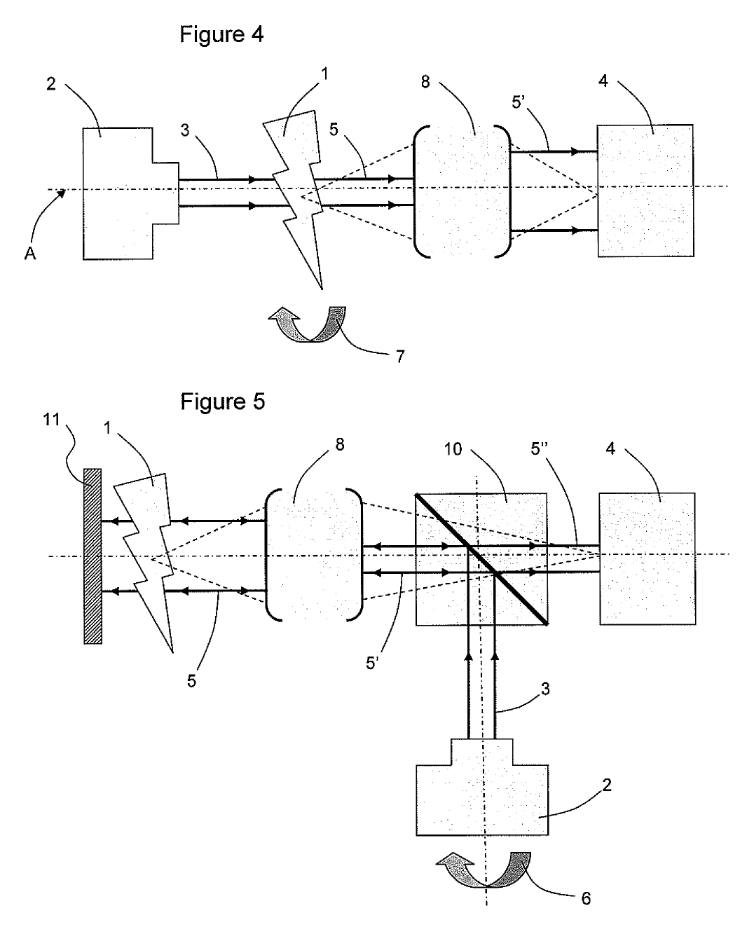

In the fourth embodiment, in reference to FIG. 4, the means for orienting the interaction 7 of the second embodiment are used. Optical conjugation means 8 are also arranged so as to conjugate the interaction surface of the object with the plane of the sensor integrated with the wavefront analyser.

The above embodiments, in reference to FIGS. 1 to 4, work by transmission onto the object 1. The fifth embodiment (FIG. 5) also works by transmission onto the object, but in order to produce a back-reflection. For this, the incident beam 3 resulting from the generating means 2 passes through a separator cube 10 (which can also be a separating plate), so as to be reflected toward the optical conjugation means 8, then the object 1.

The diffracted beam is then reflected at the level of a mirror 11. This reflected beam 5 again passes through the object 1 and the optical conjugation means 8, with the latter still conjugating the surface of interaction of the object 1 with the plane of the sensor integrated with the wavefront analyser 4. The imaged sensor 5′ again passes through the separator cube 10. The transmitted portion 5″ of this beam 5′ is then directed toward the receiving means integrating the wavefront analyser 4.

In this embodiment with back-reflection, the beam is injected in front of the imaging system 8. A person skilled in the art will note, however, that it is possible to inject the beam in front of or after the imaging system 8.

In the use of this imaging system, a person skilled in the art will understand that it is no longer necessary to implement an image reconstruction algorithm by digital propagation of the electromagnetic field generated by the input light beam 3.

Other means can be added to the structural analysis system according to the invention. In particular, according to a sixth embodiment (FIG. 6), the system can include means 13 for spectral selection of the input light beam 3. This spectral filter 13 enables the central wavelength of the illumination to be changed, and, therefore, by successive changes of the spectral filter 13, enables the chromatism of the object 1 to be measured.

It should be noted here that the use of a plurality of spectral filters can be replaced by the appropriate arrangement of a plurality of coherent sources of similar wavelengths, thereby enabling the dynamics to be increased when analysing large defects.

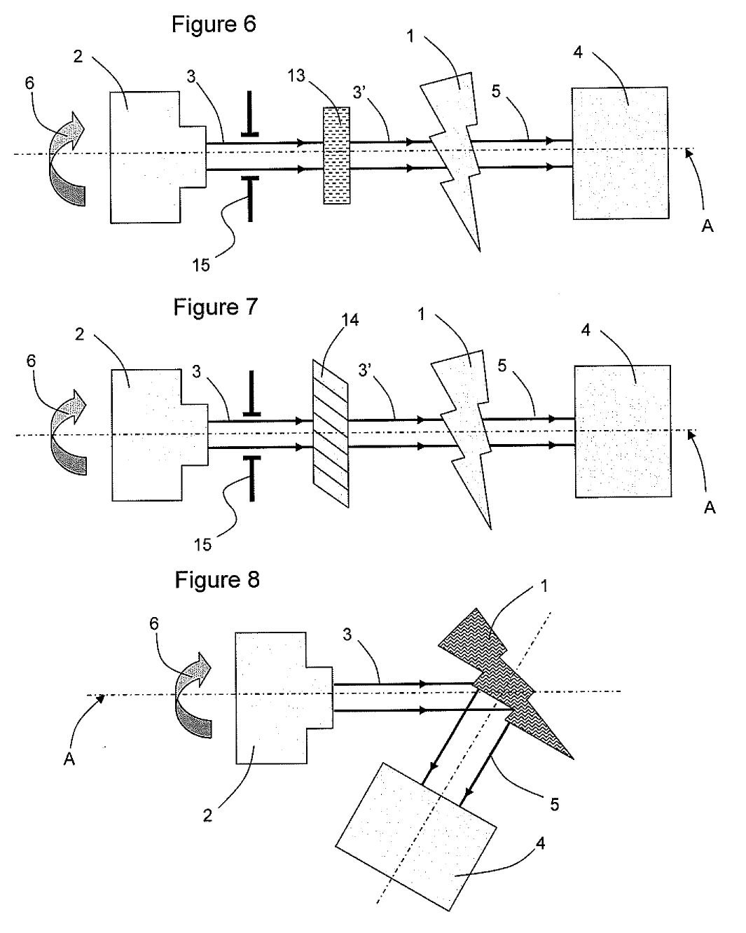

Also, according to a seventh embodiment (FIG. 7), the system can include means 14 for polarising the input beam 3. Such a polariser enables the polarisation of the incident light on the subject to be chosen, and similarly the anisotropic properties of the material constituting the object 1 to be obtained.

While the polarisation of the input beam 3 is carried out by arranging the polariser 14 between the source 2 and the object 1, it should be noted that it is also possible to polarise the beam 5 resulting from the interaction, by arranging a polariser between the object 1 and the sensor 4.

The eighth embodiment, in reference to FIG. 8, presents the case in which the object is entirely reflective and does not therefore have any transparency. In this case, it, by itself, constitutes the reflective element and it is not necessary to use a mirror in order to produce the back-reflection (as described above in reference to FIG. 5). The measurement obtained is then a surface topology.

More specifically, the source 2 is arranged in order to direct the incident beam 3 that it generates in the direction of the reflective object 1. Means 6 for orienting this source 2 make it possible to cause the angle of incidence of the beam 3 on the surface of the object 1 to be varied. Therefore, the diffracted and reflected beam 5, resulting from the interaction between the beam 3 and the object 1, is received by the receiving means integrating the wavefront analyser 4. For this, the source 2 and the sensor 4 must be on the same side of the object 1. One option thus consist of tilting the object with respect to the optical axis A of the system, with the sensor being oriented with respect to this optical axis A by an angle equal to twice the tilt angle of the object 1 with the axis A.

The above-described embodiments of the present invention are provided as examples and are in no way limiting. It is understood that a person skilled in the art is capable of producing different alternatives of the invention without going beyond the scope of the patent.

In particular, according to the nature of the object, the object can itself be the light source, which would make it unnecessary to add external means for generating an input beam, as these generating means could be considered to be inside the object.

1-12. (canceled)

13. System for structural analysis of an object in order to produce a three-dimensional reconstruction of a structure of a portion of the object analyzed according to at least one three-dimensional reconstruction method, including means for generating an input light beam, arranged so as to cause the input beam generated to interact with at least the portion of the object, and means for receiving an output light beam resulting from interaction between the input beam and the object, the receiving means including a wavefront analyser arranged so as to measure an electromagnetic field of a wave of the output beam received, and the generating means having a spatial and/or temporal coherence adapted to that of the receiving means by spatial filtering means and/or spectral filtering systems, and the generating means and the receiving means being arranged, with respect to the object, so as to obtain a plurality of successive measurements of the output light beam resulting from the interaction between the input beam and the object according to a plurality of orientations of this interaction, with the generating means having a spatial and/or temporal coherence also adapted to the three-dimensional reconstruction method used.

14. Structural analysis system according to claim 13, equipped with means for orienting the interaction, seen by the receiving means between the input light beam and the portion of the object.

15. Structural analysis system according to claim 13, wherein the generating means are structured so as to generate a plurality of input light beams capable of interacting with at least the portion of the object according to different tilts.

16. Structural analysis system according to claim 13, including means for optical conjugation between the object and the receiving means.

17. Structural analysis system according to claim 13, further comprising a plurality of generating means arranged so as to cause the interaction of a plurality of input light beams of different wavelengths with at least the portion of the object.

18. Structural analysis system according to claim 13, wherein the wavefront analyzer is a digital wavefront analyzer.

19. Structural analysis system according to claim 13, wherein the wavefront analyzer is a microlens matrix wavefront analyzer.

20. Structural analysis system according to claim 13, wherein the wavefront analyzer is a multilateral shift interferometry wavefront analyzer.

21. Structural analysis system according to claim 13, wherein the object is at least partially transparent, comprising a semi-reflective plate arranged between the generating means and the receiving means, as well as reflection means arranged so as to reflect the light passing through the object.

22. Structural analysis system according to claim 13, wherein the object is at least partially transparent, and the generating means and the receiving means are arranged on each side of the object.

23. Structural analysis system according to claim 13, wherein the object is reflective, and the generating means and the receiving means are arranged on the same side of the object.

24. Method for structural analysis of an object in order to produce a three-dimensional reconstruction of a structure of a portion of the object analyzed according to at least one three-dimensional reconstruction method, including a step of generating an input light beam capable of interacting with at least the portion of the object, and a step of receiving the output light beam resulting from the interaction between the input beam and the object, such that, when the output light beam is received, and the electromagnetic field of its wave is measured by a wavefront analyzer, and spatial and/or temporal coherence of the input light beam is adapted to that of the receiving means by spatial filtering means and/or spectral filtering systems, the generating means and the receiving means being arranged with respect to the object, a step of producing a plurality of successive measurements of the output light beam resulting from the interaction between the input beam and the object according to a plurality of orientations of this interaction, and the generating means having a spatial and/or temporal coherence also adapted to the three-dimensional reconstruction method used.
